(19) United States
(12) Patent Application Publication
(10) Pub. No.: US 2007/0272294 A1
(43) Pub. Date: Nov. 29, 2007

(54) Photocurrent Generator

(76) Inventors: Yi-Tao Long, Saskatoon (CA); Todd C. Sutherland, Saskatoon (CA); Heinz-Bernhard Kraatz, Saskatoon (CA); Jeremy S. Lee, Saskatoon (CA)

Correspondence Address: BOZICEVIC, FIELD & FRANCIS LLP, 1900 UNIVERSITY AVENUE, SUITE 200, EAST PALO ALTO, CA, 94303, US

(21) Appl. No.: 10/569,901

(22) PCT Filed: Sep. 9, 2004
(86) PCT No.: PCT/CA04/01654

§ 371 Date: Dec. 4, 2006

Related U.S. Application Data
(60) Provisional application No. 60/501,015, filed on Sep. 9, 2003.
(60) Provisional application No. 60/526,154, filed on Dec. 2, 2003.

(51) Int. Cl. H02N 6/00

(52) U.S. Cl. 136/244

(57) ABSTRACT

The invention provides systems having an electron transfer moiety tethered to an electrode by a conductive spacer moiety. A biasing potential applied to the electrode reduces the electron transfer moiety to form a reduced electron transfer species capable of absorbing a photon, to form an excited electron transfer species. An electron accepting moiety accepts an electron from the excited electron transfer species, to form a reduced electron acceptor. The reduced electron acceptor may for example be used in hydrogen generation reactions.

### FIELD OF THE INVENTION

The invention is in the field of devices for photochemical current generation.

### BACKGROUND OF THE INVENTION

A variety of gold-modified surfaces have been used to generate and analyse photocurrents [7-9]. A variety of photon acceptor groups, or combinations of groups, have been used in photocurrent generators, such as: fullerene, [6, 8,11-32] porphyrin, [5, 6, 8, 9,11, 13-16, 20, 21, 23-25, 29-31, 33-44] ferrocene, [5, 8, 13, 23, 24, 29, 36, 42, 45] Ru(bipy)₃ [29, 46-48] and pyrene.[7-9, 45], using either ITO or Au macroelectrodes. In some cases, photocurrent generation has been mediated through a biomolecular spacer group [7, 49-52].

### SUMMARY OF THE INVENTION

In alternative aspects, the invention provides systems comprising a photon accepting electron transfer moiety, such as fluorescein, tethered to an electrode (which may be any surface capable of electron transduction, i.e. an electrochemical transducer) by a conductive spacer moiety, such as a nucleic acid. A biasing potential is applied to the electrode to reduce the photon accepting electron transfer moiety to form a reduced photon accepting electron transfer species capable of absorbing a photon, such as the Fl-radical, to form an excited electron transfer species. The system further provides an electron accepting moiety, such as NAD or NADP, capable of accepting an electron from the excited electron transfer species, to form a reduced electron acceptor, such as NADH or NADPH. The electron accepting moiety may be provided in a solution containing an electrolyte that supports electron transfer, which may be called an electron transfer solution, such as an aqueous solution capable of providing protons to the reduced electron acceptor. The tethered electron transfer moiety may be immersed in the electron transfer solution, to provide for repeated electron transfer reactions between the excited electron transfer species and successive electron accepting moieties in the solution. The electrochemical species used in the system may be selected so that the bias that is applied to the electrode to form the reduced electron transfer species is less than the potential that would be required to form the reduced electron acceptor, so that an electron transfer reaction does not tend to take place on the electrode to form the reduced electron acceptor. The components of the system may be selected so that the rate at which the reduced electron transfer species is created is greater than the rate at which the excited electron transfer species donates an electron to the electron acceptor, so that when an appropriate bias is applied to the electrode, a significant proportion of the electron transfer species exist in the reduced form which is amenable to absorbing a photon to form the excited electron transfer species.

The reduced electron acceptor may for example be used in hydrogen generation reactions.

In some embodiments of the invention, an enzyme or an alternative chemical or biochemical system that utilises the reduced electron acceptor, such as NAD(P)H, may be added to the electron transfer solution to utilize the reduced electron acceptor. In such embodiments, the reduced electron acceptor may for example be a biologically active enzyme cofactor. The photoelectrochemically produced cofactor may for example be used enzymatically to drive conversion of an aldehyde to an alcohol, reduction of ketones, reductive aminations or reduction of organic acids. Accordingly, photochemically regenerated cofactors of the invention, such as NAD(P)H, may be used to drive a variety of secondary biocatalytic transformations, such as reductive transformations or biocatalytic enzyme cascades.

### BRIEF DESCRIPTION OF THE DRAWINGS

FIG. 1 is a schematic illustration showing an experimental set up for photocurrent generation using a microelectrode (as described herein, alternative embodiments may use a wide variety of electrode conformations and surface types).

FIG. 2 is a graphic representation of: (a) Dark current CVs on BAS macroelectrodes at pH 12, 50 mV·s−1 (a) in KOH, and (b) in the presence of KOH and fluorescein. (b) CVs of microelectrodes at pH 8.6, 50 mV·s−1, Light on (-) and Light off (- -). Reference electrode was Ag/AgCl.

FIG. 3 is a graphic representation of: (a) UV-visible absorbance spectra of fluorescein at various applied potential durations (vs. Ag/AgCl). i) 0 mV, ii) −750 mV, 1 min, iii) −750 mV, 2 min, iv) −750 mV, 3min, v) −750 mV, 6 min, vi) −750 mV, 10 min, vii) −750 mV, 20 min. (b) Emission spectra of fluorescein at various applied potential durations (vs. Ag/AgCl). i) 0 mV, ii) −750 mV, 1 min, iii) −750 mV, 2 min, iv) −750 mV, 3 min, v) −750 mV, 4 min.

FIG. 4 is a graphic representation of: (a) an EPR spectrum of 1:2 after bulk electrolysis at −750 mV (vs. Ag/AgCl) for 1 hour; and, (b) a simulated EPR spectrum of 1:2.

FIG. 5 is a graphic representation of data from an example of photocurrent generation by a 1:2 monolayer on an Au microelectrode, showing: (a) NADP+ in solution; (b) no NADP+ in solution; and, (c) 1:2 monolayer and NADP+ in solution radiated with 632 nm radiation (Power=10 mW cm·2).

FIG. 6 is a graphic representation of: (a) photocurrent response as a function of applied reductive potential; and, (b) Photocurrent response as a function of light intensity in the absence of NADP+(□) and in the presence of NADP+ (ο).

FIG. 7 is a graphic representation of multiple excitation responses showing a small decrease in the photocurrent as a function of repeat number.

FIG. 8 is a graphic representation of data from spectroelectrochemistry of a 1:2 monlayer on a Au mesh electrode with 0.1 mM NADP+ in solution radiated with 473 nm, 4 mW·cm-2. (a) Baseline NADP+ at 0 mV (-) and −750 mV (- -) vs. Ag/AgCl. (b) UV-visible spectra before (--) and after (-) addition of lactate dehydrogenase and pyruvate.

FIG. 9 is a schematic representation of a putative mechanism of photocurrent generation and NADP+ reduction, for conceptual purposes only (and does not necessarily depict the actual mechanism by which embodiments of the invention operate).

FIG. 10 is a schematic representation of a hydrogen generator of the invention, in which a dark reaction chamber contains a hydrogenase or alternative catalyst that utilizes a reduced electron acceptor. “NXH” (such as NADH [We can insert a description of alternative nicotinamide derivatives if you know what they will be?]) to synthesise H₂, wherein the reduced electron acceptor NXH is supplied by a light reaction of the invention, taking place in a light reaction chamber that is in fluid communication with the dark reaction chamber, in which a photon acceptor (fluorophore “F”) tethered to an electrode (an electrochemical transducing surface) mediates the synthesis of the NXH.

FIG. 11 is a graph showing UV-Visible evidence for the photo-induced electrochemical NADH production on a 1:2 modified gold mesh electrode.

FIG. 12 is a graph of UV-Visible spectra showing NADH enzymatic consumption by alcohol dehydrogenase (ADH, Baker's Yeast, Sigma-Aldrich) in the presence of acetylaldehyde.

FIG. 13. is a schematic representation of a putative mechanism of photogeneration of NADH on a self-assembled monolayer of fluorescein-labelled DNA on a gold electrode, for conceptual purposes only (and does not necessarily depict the actual mechanism by which embodiments of the invention operate).

FIGS. 14a-b. is a graphical representation of the generation of a photocurrent upon irradiation of the self-assembled monolayer on a gold electrode. (a) 473 nm with NAD+; (b) 473 nm without NAD+; 632 nm with NAD+. Scaler: Y=200 nA.cm-2, X=20 s.

FIGS. 15a-b. is a graphic representation of: (a) Current density as a function of the incident light intensity. 0, with NAD+; □, without NAD+. (b) Current density as a function of the applied potential.

FIGS. 16a-b. is a graphic representation of: (a) Spectrophotometric analysis of the photogeneration of NADH from NAD+. The peak at 340 nm corresponds to the formation of NADH. Each curve represents irradiation in steps of 5 min. The volume of the cuvette was 0.12 ml. (b) Utilization of NADH to drive the conversion of acetaldehyde (10 mM) to ethanol catalysed by NADH-dependent alcohol dehydrogenase (0.5 U/ml). The decrease in the absorbance at 340 nm corresponds to the conversion of NADH to NAD+. Each curve represents steps of 3 min. There was no change in the spectra in the absence of acetaldehyde or alcohol dehydrogenase.

### DETAILED DESCRIPTION OF THE INVENTION

In one aspect, the invention provides systems for generating a photocurrent from a self assembling monolayer (SAM) of fluorescein-labelled-DNA on gold microelectrodes. In such embodiments, fluorescein acts as a photon acceptor (or fluorophore), and DNA acts as a spacer group tethering the photon acceptor or fluorophore to the electrode surface. Fluoroscein has a relatively large molar absorptivity and is therefore likely to absorb photons for subsequent reactions[10]. The DNA spacer group was used in exemplified embodiments in part because studies of spacer length dependence have shown a decreased photocurrent for short spacer groups, suggesting that an excited-state fluorophore may be deactivated by close proximity to an electrode surface. In keeping with these limitations, other fluorophores and other spacer groups may be selected for use in the invention. Alternative spacers may for example include conductive polymers such as polypyrrols, polythiophenes, poly phenylacetylenes, peptides, polyamide or peptide nucleic acids (PNAs). Alternative photon acceptors may include porphyrins, flavins, ubiquinone, quinones, ferrocene, Ru(bipy)₃, methylene blue, methylene green, MV+, pyrene and nanoparticles (such as Au, Ag, CdSe, SdS, ZnSe, ZnS, Pd, Pt). Alternative substrates may for example include indium tin oxide (ITO), Ag, Pt and Si surfaces, which may be formed into surfaces with a wide variety of topologies, from microelectrodes to large flat surfaces. A substantially transparent ITO electrode stack may for example be adapted to provide for flow through of an electron acceptor, so that the electron acceptor (such as NAD(P)H) enters the stack on the illuminated side of the stack, and reduced electron acceptor (such as NAD(P)H) leaves the non-illuminated side of the stack, with the substantially transparent stack facilitating illumination of the system throughout the depth of the stack.

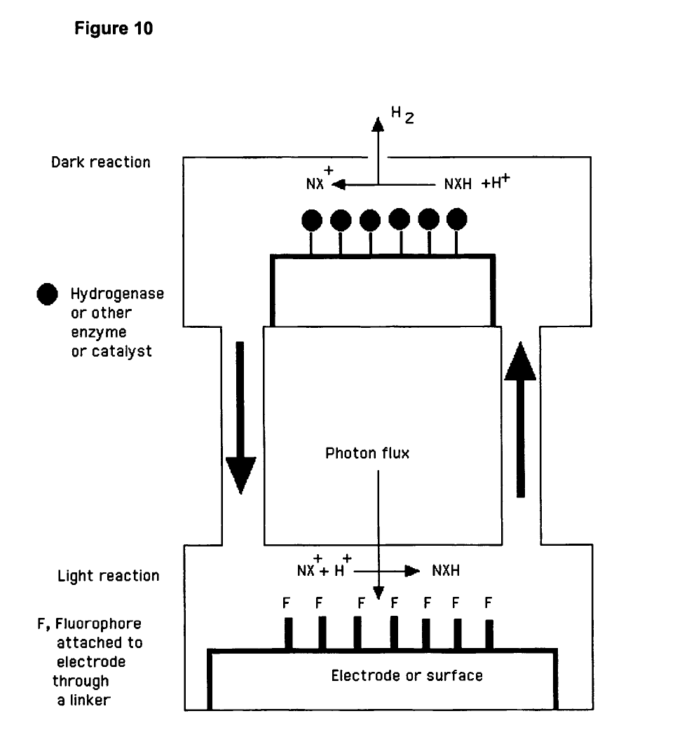

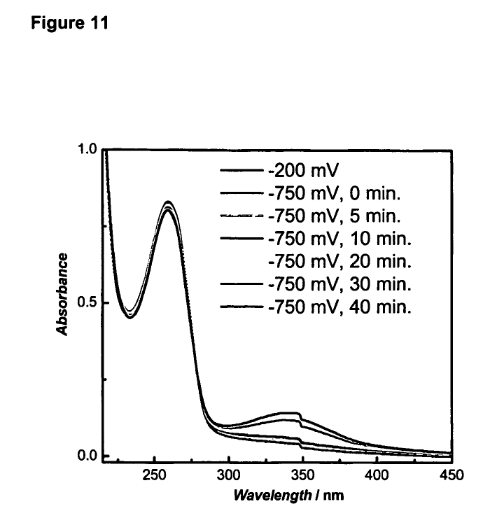

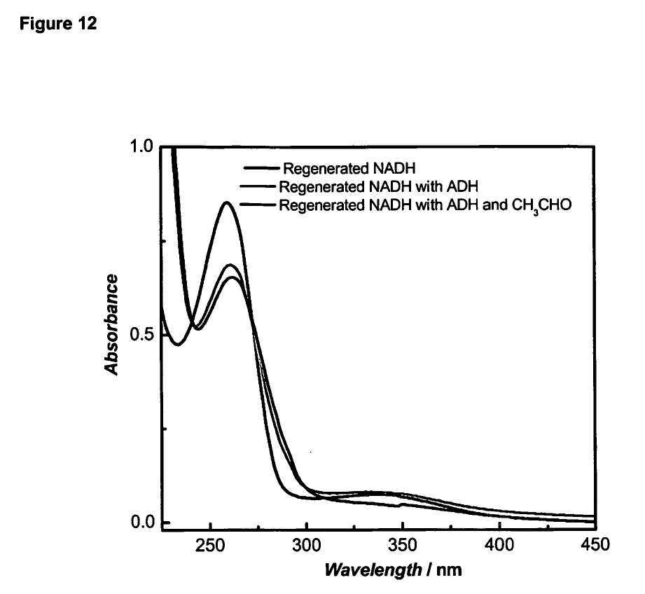

The reduced electron acceptor may for example be used in hydrogen generation reactions, as illustrated in FIG. 10. As illustrated in FIGS. 11 and 12, the NADH that is generated by the system of the invention is available for enzymatic catalysis. FIG. 11 shows photo-induced electrochemical NADH production on a 1:2 modified gold mesh electrode. FIG. 12 shows enzymatic consumption of NADH by alcohol dehydrogenase (ADH, Baker's Yeast, Sigma-Aldrich) in the presence of acetylaldehyde.

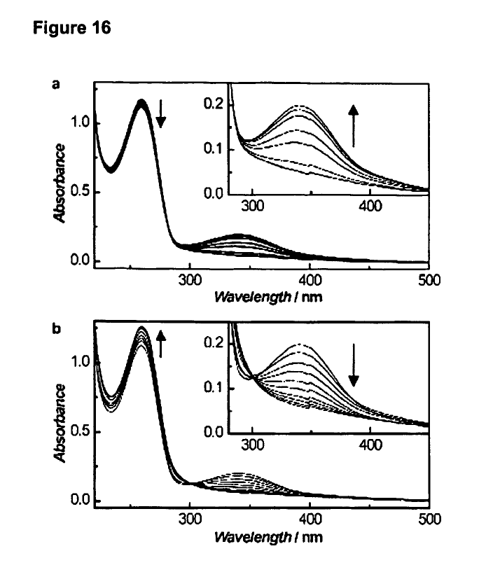

In a further embodiment of the invention, an enzymatic biochemical system that utilises the reduced electron acceptor NADH was added to the electron transfer solution, illustrating the utilization of a biologically active reduced electron acceptor. As illustrated in FIG. 16b, photoelectrochemically produced NADH was used enzymatically to drive the conversion of an aldehyde to ethanol. Under certain conditions, the process was resistant to inhibition by oxygen, organic solvents and other compounds. In alternative embodiments, reduced electron acceptors such as NAD(P)H produced by systems of the invention may be utilised in a wide variety of alternative reactions.

### EXAMPLE 1

Materials and Preparation

DNA was synthesized and purified by standard DNA synthesis methods at the Nation Research Council (Saskatoon, SK, Canada) with verification of purity and identity. Gold electrodes were prepared by melting a 50 μm Au wire fixed into soft glass that was then polished with 0.05 μm alumina slurry then cleaned by soaking in hot Piranha etching solution (H2SO4:H2O2=3:1) for 10 min. (Piranha solution should be handled with extreme care and should never be stored in a closed container, it is a very strong oxidant and reacts violently with most organic materials), and finally sonicated in Millipore H₂O. Each electrode was inspected by light microscopy to ensure that the Au electrode surface was smooth and an effective seal was made between the glass and the Au. The electrodes were than electrochemically treated by cyclic scanning form potential −0.1 to +1.25 V vs. Ag/AgCl in 0.5 M H₂SO₄ solution until obtaining a stable gold oxidation peak at 1.1 V.

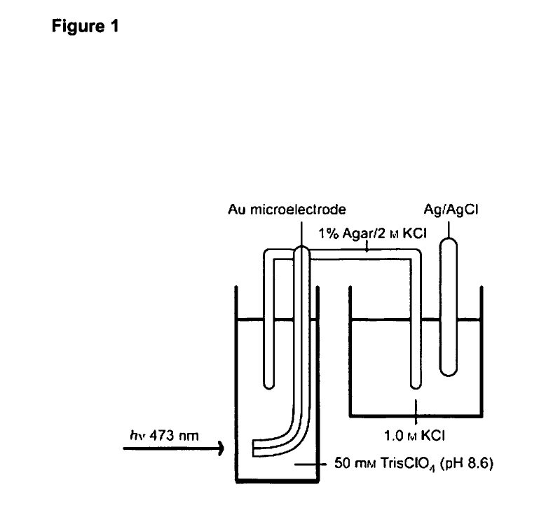

Fl-DNA modified gold electrodes were prepared by incubating the microelectrodes in 0.05 mM double stranded DNA in 50 mM Tris-ClO₄ buffer solution (pH 8.6) for 5 days. The electrodes were then rinsed with the same Tris-ClO₄ buffer and mounted into a photo-electrochemical cell, illustrated schematically in FIG. 1. The isolation of the counter electrode was beneficial to rule out counter electrode reactions that could contaminate chronoamperometry.

Photocurrent conditions were as follows. A BM73-4V laser module (Intelite Inc., Genoa, Nev., USA) laser power 4 mW·cm-2, wavelength 473±5 nm and beam diameter less than 0.8 mm was used as the excitation source. Photocurrent experiments were run under voltage-clamp conditions using an Axopatch 200B amplifier (Axon Instruments) connected to a CV 203BU headstage. A two-electrode setup was used for voltage clamp conditions with the reference electrode as a Ag/AgCl wire in a 1 M KCl solution and working electrode as the modified Au microelectrode. The spectroelectrochemical cell was enclosed in a grounded Faraday cage (Warner Instruments) and resided on an active air anti-vibration (Kinetic Systems) table. Currents were low pass Bessel filtered at 1 kHz and were digitized at 5 kHz by DigiData 1322A (Axon Instruments) and recorded by a PC running PClamp 9.0 (Axon Instruments). Further filtering was achieved by software methods using low-pass filter at 20 Hz. Analysis of all data was performed by Origin 7.0 (OriginLab Corporation). Other electrochemical measurements were performed using BAS CV-50 voltammetry analyzer and a custombuilt electrochemical system for microelectrodes using the standard 3-electrode setup. The gold microelectrode (50 μm diameter) serves as a working electrode. A reference electrode was constructed by sealing Ag/AgCl wire into a glass tube with a solution of 3 M KCl and capped with a Vycor tip. The reference electrode was isolated from the cell by a Luggin capillary containing the electrolyte. The counter electrode was a platinum wire. All electrolyte solutions were purged for a minimum of 20 min in Ar prior to the measurements, and a blanket of Ar was maintained over the solutions during the measurements. All embodiments were exemplified by operation at room temperature.

X-ray photoelectron spectroscopy was carried out as follows. A Leybold MAX200 photoelectron spectrometer equipped with an Al-Ka radiation source (1486.6 eV) was used to collect photoemission spectra. The base pressure during measurements was maintained at less than 10−9 mbar in the analysis chamber. The take-off angle was 60°. The routine instrument calibration standard was the Au 4f7/2 peak (binding energy 84.0 eV).

Electron paramagnetic resonance (EPR) was carried out as follows. The EPR spectra were recorded using a Bruker ESP300 X-band field-swept spectrometer (resonant frequency ca. 9.4 GHz) equipped with a high-sensitivity cylindrical cavity (Model 4107WZ, Bruker Spectrospin). Modulation amplitude was 0.315 G, microwave power was 20 mW, conversion time of 41 ms, time constant of 20.5 ms and 32 scans were recorded. SimFonia software was used for simulation of EPR spectra.

Results and Discussion

The synthesis of fluorescein-labeled DNA (Fl-DNA) was done using standard phosphoramidate solid support synthesis at NRC, Saskatoon, Canada. The sequences used for the photocurrent experiments are listed in Table 1. The base sequence was chosen to minimize alternative secondary or tertiary structures and incorporate equal numbers of each base. DNA melting studies were done to confirm the presence/lack of double strand formation and to ensure the fluorescein fluorophore has no significant effect on duplex stability. DNA melting curves of 1:2 duplex show no change in Tm values versus a duplex of 2:3 (56.8° C. vs. 56.4° C.), indicating that the fluorescein moiety does not significantly interfere with duplex formation.

TABLE 1

DNA sequences used for photocurrent study. F1 =
Fluorescein

| | |
|---|---|
| 1 | HO-(CH₂)₆-S-S-(CH₂)₆-5′-GTCACGATGGCCCAGTAGTT-3′- |
| | F1 |
| 2 | 5′-AACTACTGGGCCATCGTGAC-3′ |
| 3 | HO-(CH₂)₆-S-S-(CH₂)₆-5′-GTCACGATGGCCCAGTAGTT-3′ |

The duplex 1:2 was incubated with an Au microelectrode for 5 days in buffer to allow for complete monolayer formation. Monolayers were analysed by X-Ray photoelectron spectroscopy (XPS), ellipsometry and electrochemistry. The change in intensity of the Au4f7/2 peak was used to determine the monolayer thickness and gave a value of 47(5)Å, which implies that 1:2 does not form multilayer structures. The presence of S2p peak at 162 eV is evidence of an Au-thiolate bond, as expected for a 1:2 monolayer. Note that the disulfide of 1:2 is expected to cleave upon chemisorption to the Au surface and peaks at disulfide energy (164.1 eV) were not observed. Additionally, the P2p peak was measured at 134 eV, which corresponds to the phosphate backbone of DNA. The XPS results provide clear evidence that a monolayer is bonded through the sulfur to the Au surface. Ellipsometry provided a thickness of 47(3) Å for a 1:2 monolayer on Au substrates. This value agrees with previous measurements[53] of a 20-mer of DNA and is self-consistent with vales obtained by XPS and implies that the DNA adopts a significant tilt angle to the surface.

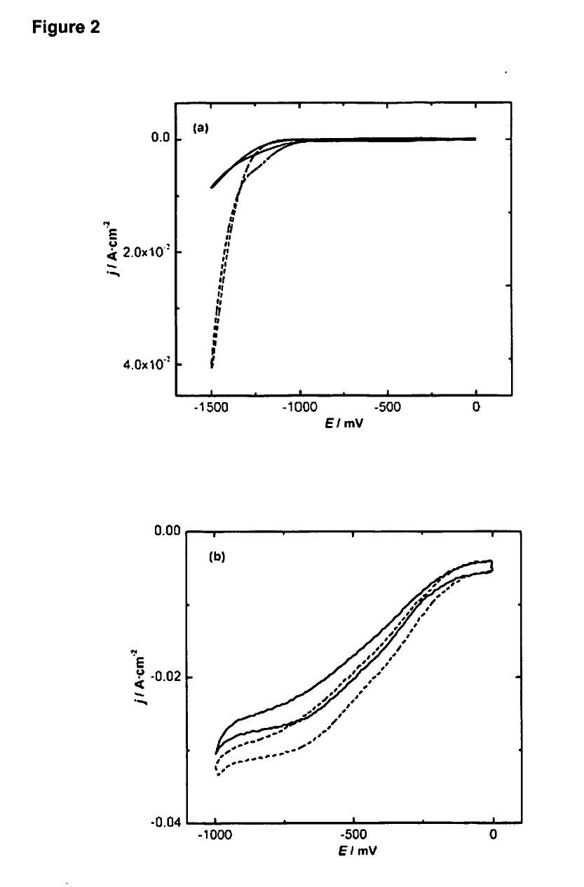

Electrochemical experiments were carried out to probe the redox potential of the fluorescein with a 1:2 monolayer. However, cyclic voltammetry (CV) experiments were complicated by the inherent nature of the fluorescein redox kinetics. The electrochemical reduction/oxidation is too slow to allow for conventional CV analysis. Although a CV, in the presence of fluorescein, is different than in the absence of fluorescein, there is no discernable reduction peak, as shown by FIG. 2a. FIG. 2b shows a bare Au CV of fluorescein in solution in the dark and upon radiation. While the electrode is exposed to radiation, there is a small change towards more positive current. Complicating matters is that the reduction potential is approximately −750 mV versus Ag/AgCl, which is relatively close to proton reduction under the pH conditions used. Therefore, due to the slow redox kinetics and the formal potential proximity to hydrogen evolution a clear reduction peak was not possible. The consequence is that surface coverage values cannot be electrochemically quantified as for a well-behaved redox probe. An approximation of surface coverage was made using the same DNA duplex except fluorescein was replaced by ferrocene (Fc). The surface coverage of this Fc monolayer has been reported at 5×10-10-10 mol·cm-2. Impedance spectroscopy (IS) was used to compare the two monolayers (1:2 versus 1-Fc:2) to verify the surface coverage approximation was valid. Clearly, the IS results show almost identical behaviour under the same conditions and therefore the surface coverage value is justified to within 20%.

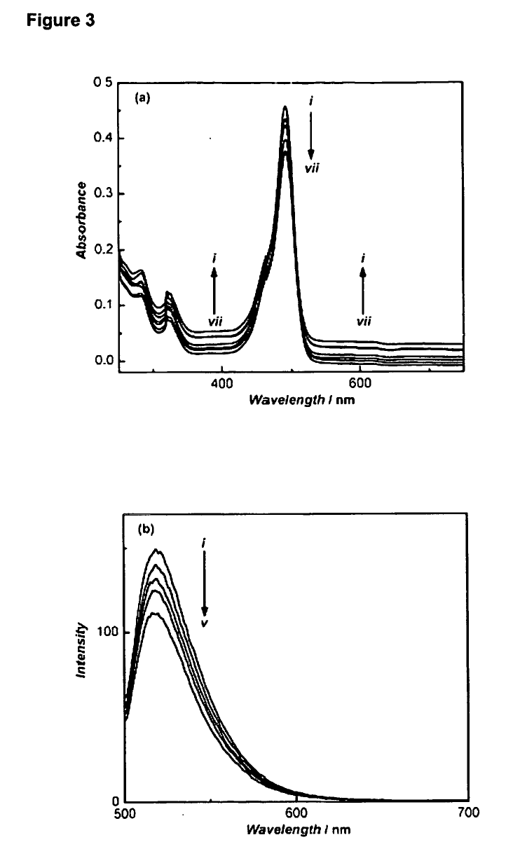

fluorescein spectroelectrochemical experiments were carried out to provide evidence of the photo species involved in the actual photocurrent generation experiments. The absorbance in the UV-visible region shows a definite change in the spectra when a potential greater in magnitude than −750 mV was applied. The spectral change is shown in FIG. 3. The decrease in the fluorescein absorbance peak (492 nm) is attributed to reduction of the fluorescein (Fl) to a fluorescein anion (Fl-). Fl- has a unique spectrum, differing from Fl, as identified by the increase in the peak in the ranges of 380-420 nm and 550-650 nm [55-57]. Concurrent with the change in the UV-visible spectra is a decrease in the fluorescein fluorescent spectra. A decrease in fluorescein fluorescent intensity shown in FIG. 3b indicates that the Fl-species has a lower quantum yield of fluorescence. It is possible that the decrease in this deactivation pathway could be caused by an increase in electron transfer (ET) deactivation pathway.

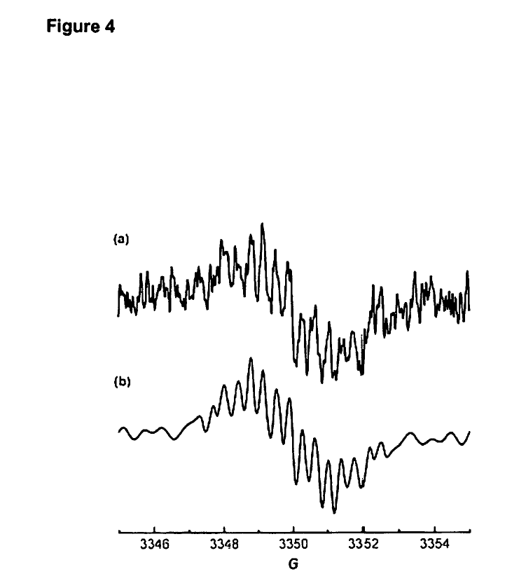

Electrochemical EPR studies of the 1:2 duplex and fluorescein have unambiguously identified the reduced Fl as a fluorescein anion radical (Fl-) at potentials greater than −750 mV. The EPR spectra of the 1:2 and fluorescein and their corresponding simulated spectra are shown in FIG. 4. The simulated spectra values used are included in Table 2, and are from prior art references [58-66].

TABLE 2
Coupling constants and unpaired spin densities for Fl and Fl-DNA proton.

| | EPR for Fl-DNA | EPR for Fl | Literature^{(66,67)} |
|---|---|---|---|
| Position of Proton | Parameters/G | Parameter/G | Fl EPR/G |
| 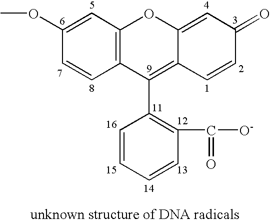 | α_{H1,8} = 3.32 α_{H2,7} = 1.38 α_{H4,5} = 0.74 α_{H13} = 0.47 α_{H14} = 0.33 α_{H15} = 0.22 α_{H16} = 0.14 (a) α_{H} = 1.52, α_{H} =1.15, α_{N} = 1.11, α_{N} = 0.36, α_{H} = 0.69 | | |
| # (b) α_{H} = 0.89, α_{H} = 1.04, α_{N} = 1.69, α_{N} = 0.23, α_{H} = 0.01 | α_{H1,8} = 3.35 α_{H2,7} = 1.42 α_{H4,5} = 0.71 α_{H13} = 0.61 α_{H14} = 0.30 α_{H15} = 0.20 α_{H16} = 0.17 | | |
| # α_{H1,8} = 3.29 α_{H2,7} = 1.51 α_{H4,5} = 0.90 α_{H13} = 0.22 α_{H14} = 0.19 α_{H15} = 0.17 α_{H16} = 0.09 (a) α_{H} = 1.61, α_{H} =1.00, α_{N} = 0.52, α_{N} = 0.24, | | | |
| # α_{H} = 0.04 (b) α_{H} = 1.71, α_{H} = 1.16, α_{N} = 1.16, α_{N} = 0.52, α_{H} = 0.01 | | | |

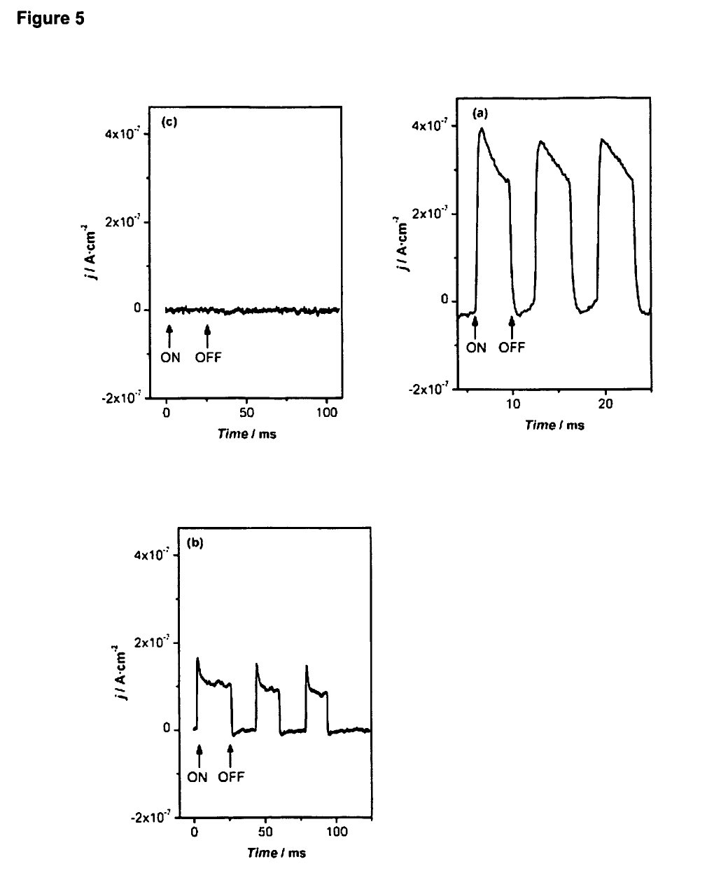

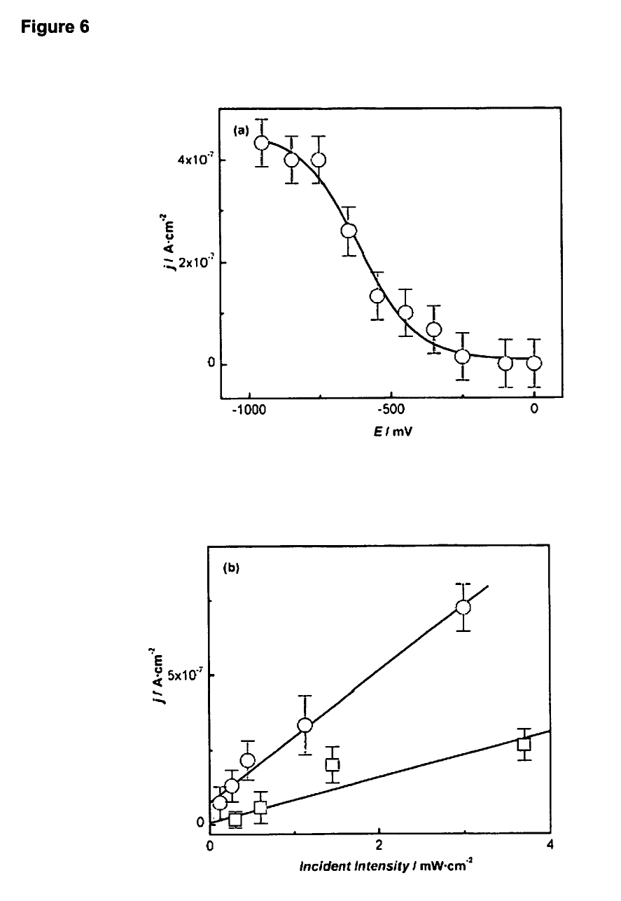

Irradiation of the 1:2 monolayer results in photocurrent generation at an applied potential of −750 mV, as shown by FIG. 5. When the negative potential is applied, the excited state Fl-radical becomes available to transfer an electron to generate current provided there is a suitable electron acceptor. In this example, NADP+ was added to the solution as the acceptor group. Importantly, NADP+ is not 10 electrochemically reduced in the potential region necessary for photocurrent generation, so that reduction of the NADP+ electron acceptor on the electrode is not likely. A photocurrent was observed in the absence of NADP+ (FIG. 6b) but was greatly enhanced in its presence (FIG. 6a). Irradiation with red laser light (632 nm, 10 mW·cm-2) resulted in no photocurrent generation (FIG. 6c).

NADP+ is a very important chemical energy store for the dark reactions of photosynthesis and, as such, could be exploited for energy storage in abiological systems. FIG. 6a illustrates the resulting current generated from the radiation of the monolayer as a function of applied potential. The current hits a maximum value at approximately −750 mV and falls off dramatically at lower applied potentials. The maximum at −750 mV is evidence that the fluorescein is reduced to its radical anion before radiation and subsequent electron transfer. A linear relationship was found between the intensity of the incident laser and the output photocurrent, shown in FIG. 6b.

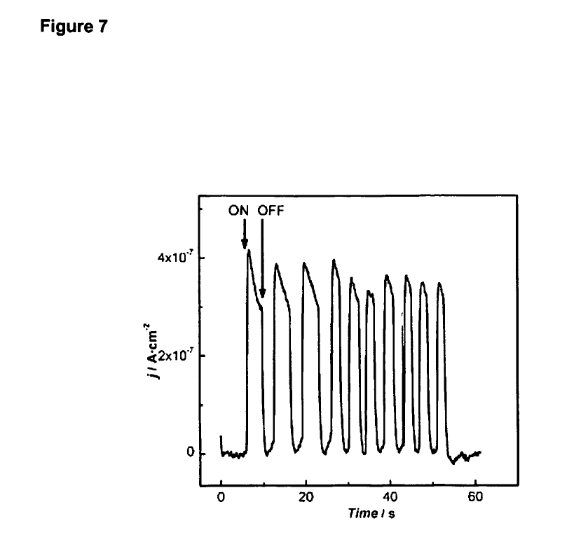

The availability of the monolayer for multiple laser excitations was assessed by repeated exposures of laser light. The resulting photocurrents do diminish with increases in the number of exposures, as shown in FIG. 7. However, the magnitude of the decrease in photocurrent is relatively small.

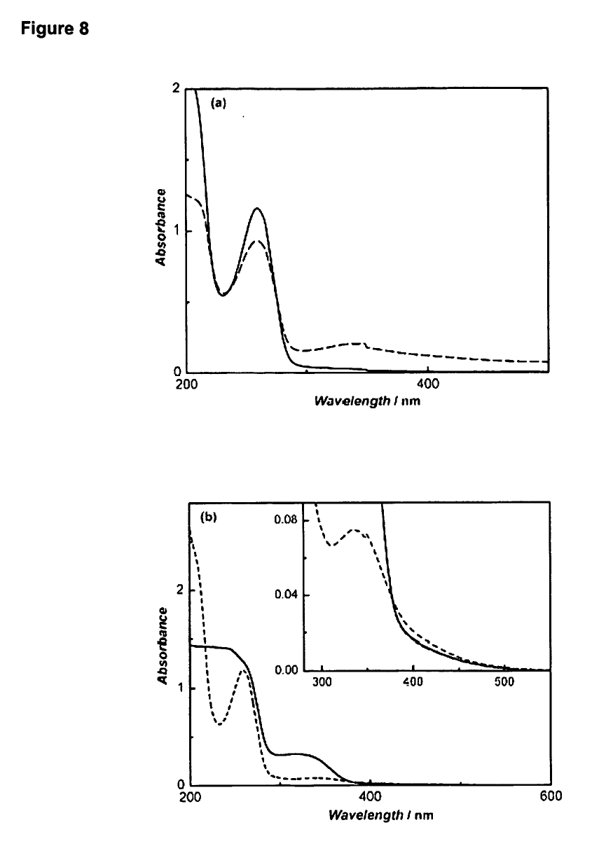

The formation of NADPH in the system of the invention is evidenced by the growth of a peak at 340 nm in a solution containing NADP+ and a monolayer of 1:2 (FIG. 8a) [68-70]. It is common for dimers of NADP+ to form under electrochemical reduction and these dimers also have an absorption peak at 340 nm.[68-71]

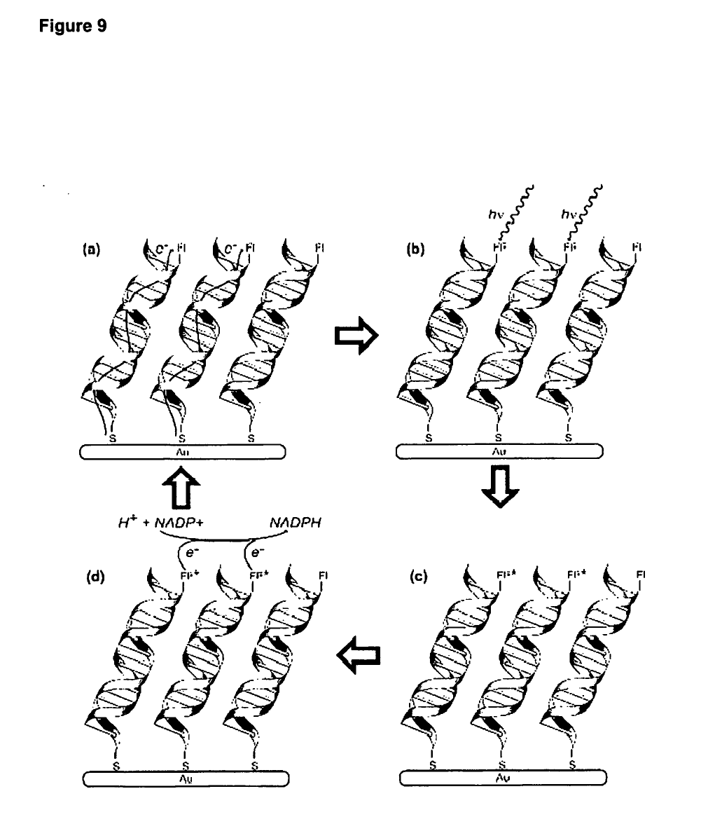

A putative photocurrent generation scheme in accordance with one aspect of the invention is outlined in FIG. 9. The first step (FIG. 10a) may be to reduce the fluorescein to the radical anion via electron transfer from the Au surface, through the double helix of DNA and to the covalently attached fluorescein. The fluorescein radical anion appears to have an extraordinarily long lifetime (measured in hours). For this reason, it appears that Fl-is able to survive long enough to absorb a photon. Once the fluorescein radical anion absorbs a photon (FIG. 10b) of appropriate energy to form the excited state fluorescein radical anion (FIG. 10c) it can then return to the ground state by donating its electron to the diffusing NADP+. However, NADP+ is a two-electron acceptor. Therefore, an adjacent, or possibly even the same strand becomes reduced and excited again, to donate the second electron to the NADP. The protonation of the NADP-is facilitated in this system which is contained in an aqueous medium.

Equation 1 relates to a measure of quantum efficiency, as a characteristic of the photoelectrochemical process. Quantum efficiency (φ) may be defined by the ratio of the number of electrons (dNₑ/dt, electrons/s) taking part in the photoelectrochemical reaction and the number of photons absorbed per unit time by photoactive molecules (dNₕᵥ/dt, photons/s) [7, 8, 12, 14, 16, 21, 24, 30, 32, 33, 36, 37, 40, 72-76].

$$Φ = \frac{( \frac{\partial {N}_{{e}^{-}}}{\partial t} )}{( \frac{\partial {N}_{hv}}{\partial t} )} \qquad ( 1 )$$

Under excitation with λ=473(5) nm laser light with a power of 4 mW/cm2, a photocurrent density of 450 nA·cm⁻² was obtained for a Fl-DNA labeled microelectrode at the applied potential of −750 mV (vs. Ag/AgCl). Assuming the molar absorption coefficient of Fl-DNA (ε473, 43 000 M−1 cm-1) on the electrode surface is the same as that in solution; the quantum efficiency was calculated to be 0.25(5). The value is much larger than those reported for a porphyrin SAM (0.1%) [35], a multilayered pyrene containing system on gold surface (1%),[7] and comparable to those (7.5˜35%) in C₆₀ SAM systems [8, 18, 21-25].

Although various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way. Numeric ranges are inclusive of the numbers defining the range. The word “comprising” is used herein as an open-ended term, substantially equivalent to the phrase “including, but not limited to”, and the word “comprises” has a corresponding meaning. As used herein, the singular forms “a”, “an” and “the” include plural referents unless the context clearly dictates otherwise. Thus, for example, reference to “a thing” includes more than one such thing. Citation of references herein is not an admission that such references are prior art to the present invention. Any priority document(s) and all publications, including but not limited to patents and patent applications, cited in this specification are incorporated herein by reference as if each individual publication were specifically and individually indicated to be incorporated by reference herein and as though fully set forth herein. The invention includes all embodiments and variations substantially as hereinbefore described and with reference to the examples and drawings.

### EXAMPLE 2

Materials and Preparation

Electrodes: Gold microelectrodes (50 μm diameter) were prepared and characterized as described previously [104]. Gold mesh was purchased from Alfa Aesar (99.9% purity, 52 mesh woven from 0.1 mm diameter wire) and spot-welded to a 0.1 mm diameter Au (ibid) lead. The Au mesh assembly was cleaned by immersing in boiling piranha solution (1:3 H2O2:H2SO4) for 10 minutes. (Piranha solution should be handled with extreme care and should never be stored in a closed container, it is a very strong oxidant and reacts violently with most organic materials).

Fluorescein-DNA construct: The DNA was synthesized and purified by standard DNA synthesis methods at the Nation Research Council (Saskatoon, SK, Canada). The sequences used for the photocurrent experiments are listed in Table 4. The base sequence was chosen to minimize alternative secondary or tertiary structures and incorporate equal numbers of each base.

TABLE 4
DNA sequences used for photocurrent study. F1 =
Fluorescein

| | |
|---|---|
| 1 | HO-(CH₂)₆-S-S-(CH₂)₆-5′-GTCACGATGGCCCAGTAGTT-3′- |
| | F1 |
| 2 | 5′-AACTACTGGGCCATCGTGAC-3′ |

Preparation of Fl-DNA modified gold electrodes: The microelectrodes and mesh electrodes were incubated in 0.05 mM fluorescein-labelled double stranded DNA in 50 mM Tris-ClO₄ buffer solution (pH 8.6) for 5 days as described previously

Photocurrent conditions: The electrodes were then rinsed with the Tris-ClO₄ buffer and mounted into a photo-electrochemical cell, as illustrated in FIG. 1. Where applicable NAD(P)+ was added to a final concentration of 2 mM. The isolation of the counter electrode was necessary to rule out counter electrode reactions that could contaminate the chronoamperometry. A BM73-4V laser module (Intelite Inc., Genoa, Nev., USA) laser power 4 mW·cm-2, wavelength 473±5 nm and beam diameter less than 0.8 mm was used as the excitation source. Photocurrent experiments were run under voltage-clamp conditions using an Axopatch 200B amplifier (Axon Instruments) connected to a CV 203BU headstage. A two-electrode setup was used for voltage clamp conditions with the reference electrode as a Ag/AgCl wire in a 1 M KCl solution and working electrode as the modified Au microelectrode. The spectroelectrochemical cell was enclosed in a grounded Faraday cage (Warner Instruments) and was placed on an active air anti-vibration (Kinetic Systems) table.

Currents were low pass Bessel filtered at 1 kHz and were digitized at 5 kHz by DigiData 1322A (Axon Instruments) and recorded by a PC running PClamp 9.0 (Axon Instruments). Further filtering was required and achieved by software methods using low-pass filter at 20 Hz. Analysis of all data was performed by Origin 7.0 (OriginLab Corporation). Other electrochemical measurements were performed using custom-built potentiostat designed for microelectrodes using the standard 3-electrode setup. The gold microelectrode (50 μm diameter) serves as a working electrode. A reference electrode was constructed by sealing Ag/AgCl wire into a glass tube with a solution of 3 M KCl and capped with a Vycor tip. The reference electrode was always isolated from the cell by a Luggin capillary containing the electrolyte. The counter electrode was a platinum wire. All electrolyte solutions were purged for a minimum of 20 min in Ar prior to the measurements, and a blanket of Ar was maintained over the solutions during the measurements. All experiments were conducted at room temperature.

Results and Discussion

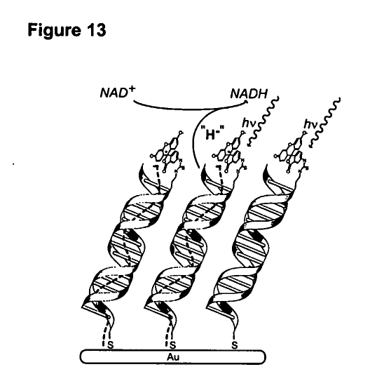

Upon transfer of an electron, a stable radical anion of the chromophore is putatively formed. The chromophore may then be excited with radiation (473 nm). In this way, back electron transfer may be suppressed. As exemplified, fluorescein (Fl) may be selected as the chromophore and utilized under conditions adapted so that it forms a stable radical anion at a modest reduction potential (−750 mV vs Ag/AgCl) with a large absorption coefficient (ε473=43 000 M−1 cm-1). In this example, the chromophore was attached to the gold electrode through a 20 base-pair duplex DNA via a thiol linkage as illustrated in FIG. 13. The DNA spacer may help to prevent the excited-state Fl from being quenched by close proximity to the electrode surface while at the same time, the semiconductive properties of DNA may facilitate electron transfer from the electrode to the chromophore. At an applied potential of −750 mV (vs. Ag/AgCl), Fl appears to formthe anion radical Fl•- as shown by EPR spectroscopy (FIG. 4). A suitable electron acceptor may be chosen to facilitate continuous current to flow. In the exemplified embodiment,NAD(P)+(ie. either NAD+ or NADP+) was chosen as an electron acceptor having a reduction potential higher than that of the chromophore fluorescein.

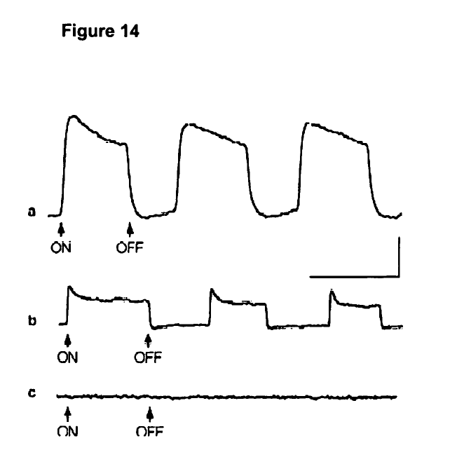

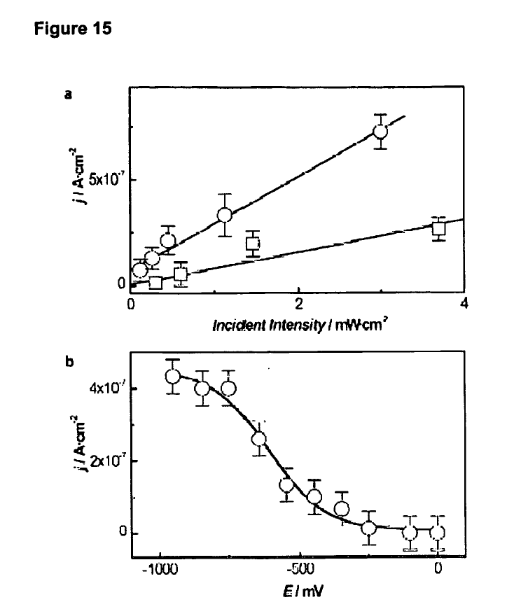

As illustrated in FIG. 14a, irradiation of the microelectrode at 473 nm with a 4 mW·cm-2 laser produces a sustained current, with little reduction in the magnitude with multiple irradiations. In the absence of NAD(P)+, as illustrated in FIG. 14b, the current was reduced by at least 50%. No current was observed with red laser light (632 nm,10mW/cm2) at a wavelength not absorbed by fluorescein, as illustrated in FIG. 14c. No photocurrent was produced when a monolayer of unlabeled fluorescein DNA was used. Both NAD+ and NADP+ produce equal quantum yields of photocurrent. A linear relationship was found between the intensity of the photon flux and the current output in the presence or absence of NAD(P)+ as illustrated in FIG. 15a. The current reached a plateau at a reductive potential of −750 mV as illustrated in FIG. 15b, providing evidence that Fl was first reduced to its radical anion before irradiation and subsequent electron transfer.

Under Fl-excitation conditions, a photocurrent density of 450 nA·cm-2 was obtained for a Fl-DNA labeled microelectrode at the applied potential of −750 mV (vs. Ag/AgCl). Assuming that the molar absorption coefficient of Fl-DNA on the electrode surface is the same as that in solution, the efficiency was calculated to be 4(1) photons-electron−1 (equivalent to a quantum yield of about 25%). To illustrate the production of NAD(P)H, an embodiment was implemented on a larger scale with a gold mesh electrode, with the solution monitored spectrophotometrically. As illustrated in FIG. 16a, a UV-vis peak at 340 nm, which is characteristic of NADH (ε340=6220 M−1 cm-1 ) appears upon irradiation. Nicotinamide coenzymes have been shown to form biologically inactive dimers from radicals produced by single electron reductions. In order to show that NADH was biologically active and not a dimer, alcohol dehydrogenase and acetaldehyde were added to the solution. As illustrated in FIG. 16b, the peak at 340 nm is eliminated demonstrating that the photoelectrochemically produced NADH can be used enzymatically to drive the conversion of an aldehyde to ethanol. The formation of non-biologically active NAD+ reduction products, which also have a peak at 340 nm, was estimated to be less than 1%.

### REFERENCES

The following documents are incorporated herein by reference:

[1] Miyasaka, T., Atake, T., Watanabe, T., Chem. Lett. 2003, 32, 144-5.

[2] Byrd, H., Suponeva, E. P., Bocarsly, A. B., Thompson, M. E., Nature 1996, 380, 610-2.

[3] Morita, T., Kimura, S., Kobayashi, S., Imanishi, Y., J. Am. Chem. Soc. 2000,122, 2850-9.

[4] Morita, T., Kimura, S., Kobayashi, S., Imanishi, Y., Chem. Lett. 2000, 676-7.

[5] Kondo, T., Yanagida, M., Zhang, X. Q., Uosaki, K., Chem. Left. 2000, 964-5.

[6] Ikeda, A., Hatano, T., Shinkai, S., Akiyama, T., Yamada, S., J. Am. Chem. Soc. 2001, 123, 4855-6.

[7] Soto, E., Macdonald, J. C., Cooper, C. G. F., Mcgimpsey, W. G., J. Am. Chem. Soc. 2003, 125, 2838-9.

[8] Imahori, H., Norieda, H., Yamada, H., Nishimura, Y., Yamazaki, I., Sakata, Y., Fukuzumi, S., J. Am. Chem. Soc. 2001,123, 100-10.

[9] Imahori, H., Nishimura, Y., Norieda, H., Karita, H., Yamazaki, I., Sakata, Y., Fukuzumi, S., Chem. Commun. 2000, 661-2.

[10] Torimura, M., Kurata, S., Yamada, K., Yokomaku, T., Kamagata, Y., Kanagawa, T., Kurane, R., Anal. Sci. 2001, 17, 155-60.

[11] Akiyama, T., Imahori, H., Ajawakom, A., Sakata, Y., Chem. Left. 1996, 907-8.

[12] Enger, O., Nuesch, F., Fibbioli, M., Echegoyen, L., Pretsch, E., Diederich, F., J. Mater. Chem. 2000,10, 2231-3.

[13] Fujitsuka, M., Ito, O., Imahori, H., Yamada, K., Yamada, H., Sakata, Y., Chem. Lett. 1999, 721-2.

[14] Fukuzumi, S., Imahori, H., Okamoto, K., Yamada, H., Fujitsuka, M., Ito, O., Guldi, D. M., J. Phys. Chem. A 2002, 106, 1903-8.

[15] Guldi, D. M., Pellarini, F., Prato, M., Granito, C., Troisi, L., Nano Lett. 2002, 2, 965-8.

[16] Hasobe, T., Imahori, H., Yamada, H., Sato, T., Ohkubo, K., Fukuzumi, S., Nano Lett. 2003, 3, 409-12.

[17] Hatano, T., Ikeda, A., Akiyama, T., Yamada, S., Sano, M., Kanekiyo, Y., Shinkai, S., J. Chem. Soc.- Perkin Trans. 2 2000, 5, 909-12.

[18] Hirayama, D., Yamashiro, T., Takimiya, K., Aso, Y., Otsubo, T., Norieda, H., Imahori, H., Sakata, Y., Chem. Lett. 2000, 570-1.

[19] Hirayama, D., Takimiya, K., Aso, Y., Otsubo, T., Hasobe, T., Yamada, H., Imahori, H., Fukuzumi, S., Sakata, Y., J. Am. Chem. Soc. 2002,124, 532-3.

[20] Imahori, H., Yamada, K., Hasegawa, M., Taniguchi, S., Okada, T., Sakata, Y., Angew. Chem.-Int. Edit. 1997, 36, 2626-9.

[21] Imahori, H., Azuma, T., Ajavakom, A., Norieda, H., Yamada, H., Sakata, Y., J. Phys. Chem. B 1999,103, 7233-7.

[22] Imahori, H., Azuma, T., Ozawa, S., Yamada, H., Ushida, K., Ajavakom, A., Norieda, H., Sakata, Y., Chem. Commun. 1999, 557-8.

[23] Imahori, H., Yamada, H., Ozawa, S., Ushida, K., Sakata, Y., Chem. Commun. 1999,1165-6.

[24] Imahori, H., Yamada, H., Nishimura, Y., Yamazaki, I., Sakata, Y., J. Phys. Chem. B 2000, 104, 2099- 108.

[25] Imahori, H., Hasobe, T., Yamada, H., Kamat, P. V., Barazzouk, S., Fujitsuka, M., Ito, O., Fukuzumi, S., Chem. Lett. 2001, 784-5.

[26] Kuo, C., Kumar, J., Tripathy, S. K., Chiang, L. Y., J. Macromol. Sci., Chem. 2001, A38,1481-98.

[27] Shi, Y., Zhang, W., Gan, L., Huang, C., Luo, H., Li, N., Thin Solid Films 1999, 352, 218-22.

[28] Sudeep, P. K., Ipe, B. I., Thomas, K. G., George, M. V., Barazzouk, S., Hotchandani, S., Kamat, P. V., Nano Lett. 2002, 2, 29-35.

[29] Terasaki, N., Akiyama, T., Yamada, S., Langmuir 2002, 18, 8666-71.

[30] Yamada, H., Imahori, H., Fukuzumi, S., J. Mater. Chem. 2002,12, 2034-40.

[31] Yamada, H., Imahori, H., Nishimura, Y., Yamazaki, I., Fukuzumi, S., Adv. Mater. 2002, 14, 892-5.

[32] Zhang, S., Dong, D., Gan, L., Liu, Z., Huang, C., New J. Chem. 2001, 25, 606-10.

[33] Abdelrazzaq, F. B., Kwong, R. C., Thompson, M. E., J. Am. Chem. Soc. 2002,124, 4796-803.

[34] He, X., Zhou, Y., Zhou, Y., Wang, L., Li, T., Bi, Z., Zhang, M., Shen, T., J. Mater. Chem. 2000,10, 873-7.

[35] Imahori, H., Norieda, H., Ozawa, S., Ushida, K., Yamada, H., Azuma, T., Tamaki, K., Sakata, Y., Langmuir 1998, 14, 5335-8.

[36] Imahori, H., Norieda, H., Nishimura, Y., Yamazaki, I., Higuchi, K., Kato, N., Motohiro, T., Yamada, H., Tamaki, K., Arimura, M., Sakata, Y., J. Phys. Chem. B 2000, 104, 1253-60.

[37] Imahori, H., Hasobe, T., Yamada, H., Nishimura, Y., Yamazaki, I., Fukuzumi, S., Langmuir 2001, 17, 4925-31.

[38] Ishida, A., Majima, T., Chem. Phys. Left. 2000, 322, 242-6.

[39] Kondo, T., Yanagida, M., Nomura, S., Ito, T., Uosaki, K., J. Electroanal. Chem. 1997, 438,121-6.

[40] Lahav, M., Gabriel, T., Shipway, A. N., Willner, I., J. Am. Chem. Soc. 1999,121, 258-9.

[41] Nomoto, A., Mitsuoka, H., Ozeki, H., Kobuke, Y., Chem. Commun. 2003,1074-5.

[42] Uosaki, K., Kondo, T., Zhang, X.-Q., Yanagida, M., J. Am. Chem. Soc. 1997,119, 8367-8.

[43] Yamada, K., Imahori, H., Nishimura, Y., Yamazaki, I., Sakata, Y., Chem. Lett. 1999, 895-6.

[44] Yamada, H., Imahori, H., Nishimura, Y., Yamazaki, I., Fukuzumi, S., Chem. Commun. 2000,1921-2.

[45] Sakomura, M., Fujihira, M., Thin Solid Films 1996, 273, 181-4.

[46] Chen, J., Mitsuishi, M., Aoki, A., Miyashita, T., Chem. Commun. 2002, 2856-7.

[47] Koide, Y., Terasaki, N., Akiyama, T., Yamada, S., Thin Solid Films 1999, 350, 223-7.

[48] Li, L., Ruzgas, T., Gaigalas, A. K., Langmuir 1999, 15, 6358-63.

[49] Wang, L. L., Silin, V., Gaigalas, A. K., Xia, J. L., Gebeyehu, G., J. Colloid Interface Sci. 2002, 248, 404-12.

[50] Lassalle, N., Mailley, P., Vieil, E., Livache, T., Roget, A., Correia, J. P., Abrantes, L. M., J. Electroanal. Chem. 2001, 509, 48-57.

[51] Lassalle, N., Vieil, E., Correia, J. P., Abrantes, L. M., Biosens. Bioelectron. 2001, 16, 295-303.

[52] Lassalle, N., Vieil, E., Correia, J. P., Abrantes, L. M., Synth. Met. 2001, 119, 407-8.

[53] Long, Y.-T., Li, C.-Z., Sutherland, T. C., Chama, M., Lee, J. S., Kraatz, H.-K., J. Am. Chem. Soc. 2003, in press.

[54] Daly, P. J., Page, D. J., Compton, R. G., Anal. Chem. 1983, 55, 1191-2.

[55] Kruger, U., Memming, R., Ber. Bunsen-Ges. Phys. Chem. 1974, 78, 670-8.

[56] Kruger, U., Memming, R., Ber. Bunsen-Ges. Phys. Chem. 1974, 78, 685-92.

[57] Langbein, H., Friedrich, M., Paetzold, R., Zeitschrift fuer Physikalische Chemie (Muenchen, Germany) 1982, 133, 99-105.

[58] Compton, R. G., Coles, B. A., Pilkington, M. B. G., J. Chem. Soc., Faraday Trans. 11988, 84, 4347-57.

[59] Compton, R. G., Coles, B. A., Pilkington, M. B. G., Journal of the Chemical Society, Faraday Transactions 1: Physical Chemistry in Condensed Phases 1988, 84, 4347-57.

[60] Compton, R. G., Daly, P. J., Unwin, P. R., Waller, A. M., Journal of Electroanalytical Chemistry and Interfacial Electrochemistry 1985, 191, 15-29.

[61] Compton, R. G., Harland, R. G., Pilkington, M. B. G., Stearn, G. M., Unwin, P. R., Waller, A. M., Portugaliae Electrokimica Acta 1987, 5, 271-9.

[62] Compton, R. G., Harland, R. G., Unwin, P. R., Waller, A. M., Journal of the Chemical Society, Faraday Transactions 1: Physical Chemistry in Condensed Phases 1987, 83, 1261-8.

[63] Compton, R. G., Mason, D., Unwin, P. R., Journal of the Chemical Society, Faraday Transactions 1: Physical Chemistry in Condensed Phases 1988, 84, 2057-68.

[64] Compton, R. G., Mason, D., Unwin, P. R., Journal of the Chemical Society, Faraday Transactions 1: Physical Chemistry in Condensed Phases 1988, 84, 483-9.

[65] Compton, R. G., Pilkington, M. B. G., Journal of the Chemical Society, Faraday Transactions 1: Physical Chemistry in Condensed Phases 1989, 85, 2255-71.

[66] Nizuma, S., Sato, Y., Konishi, S., Kokubun, H., Bull. Chem. Soc. Jpn. 1974, 47, 2121-5.

[67] Geimer, J., Hildenbrand, K., Naumov, S., Beckert, D., Phys. Chem. Chem. Phys. 2000, 2, 4199-206.

[68] Dicosimo, R., Wong, C.-H., Daniels, L., Whitesides, G. M., J. Org. Chem. 1981, 46,4622-3.

[69] Moiroux, J., Elving, J., J. Am. Chem. Soc. 1980, 102, 6533-8.

[70] Matsue, T., Chang, H.-C., Uchida, I., Osa, T., Tetrahedron Left. 1988, 29,1551-4.

[71] Suye, S.-l., Aramoto, N., Nakamura, M., Tabata, I., Sakakibara, M., Enzyme Microb. Technol. 2002, 30,13944.

[72] Emeline, A. V., Kuzmin, G. N., Purevdorj, D., Ryabchuk, V. K., Serpone, N., J. Phys. Chem. B 2000, 104, 2989-99.

[73] Li, F.-Y., Huang, C.-H., Jin, L.-P., Wu, D.-G., Zhao, X.-S., J. Mater. Chem. 2001, 11, 3002-7.

[74] Miyake, M., Torimoto, T., Sakata, T., Mori, H., Yoneyama, H., Langmuir 1999, 15,1503-7.

[75] Pardo-Yissar, V., Katz, E., Wasserman, J., Willner, I., J. Am. Chem. Soc. 2003, 125, 622-3.

[76] Wu, D.-G., Huang, C.-H., Gan, L.-B., Zheng, J., Huang, Y.-Y., Zhang, W., Langmuir 1999, 15, 7276- 81.

[77] Dryhurst, G., M., K. K. & Scheller., F. Biological Electrochemistry (Academic Press, New York, 1982).

[78] Imahori, H. et al. Photoinduced electron transfer at a gold electrode modified with a self-assembled monolayer of fullerene. Chem. Commun., 557-558 (1999).

[79] Hatano, T. et al. Facile construction of an ultra-thin 60 fullerene layer from 60 fullerene-homooxacalix-3-arene complexes on a gold surface. J. Chem. Soc.-Perkin Trans. 2 5, 909-912 (2000).

[80] Ikeda, A., Hatano, T., Shinkai, S., Akiyama, T. & Yamada, S. Efficient photocurrent generation in novel self-assembled multilayers comprised of 60 fullerene-cationic homooxacalix-3-arene inclusion complex and anionic porphyrin polymer. J. Am. Chem. Soc. 123, 4855-4856 (2001).

[81] Imahori, H. et al. A sequential photoinduced electron relay accelerated by fullerene in a porphyrin-pyromellitimide-C-60 triad. Angew. Chem.-Int. Ed. 36, 2626-2629 (1997).

[82] Imahori, H. et al. Chain length effect on photocurrent from polymethylene-linked porphyrins in self-assembled monolayers. Langmuir 14, 5335-5338 (1998).

[83] Imahori, H. et al. Photoinduced energy transfer in mixed self-assembled monolayers of pyrene and porphyrin. Chem. Commun., 661-662 (2000).

[84] Imahori, H. et al. Light-harvesting and photocurrent generation by gold electrodes modified with mixed self-assembled monolayers of boron-dipyrrin and ferrocene-porphyrin-fullerene triad. J. Am. Chem. Soc. 123, 100-110 (2001).

[85] Kondo, T., Yanagida, M., Zhang, X. Q. & Uosaki, K. Effect of surface morphology of a gold substrate on photocurrent efficiency at a gold electrode modified with a self-assembled monolayer of a porphyrin-ferrocene-thiol linked molecule. Chem. Lett., 964-965 (2000).

[86] Uosaki, K., Kondo, T., Zhang, X.-Q. & Yanagida, M. Very efficient visible-light-induced uphill electron transfer at a self-assembled monolayer with a porphyrin-ferrocene-thiol linked molecule. J. Am. Chem. Soc. 119, 8367-8368 (1997).

[87] Chen, J., Mitsuishi, M., Aoki, A. & Miyashita, T. Photocurrent amplification by an energy/electron transfer cascade in polymer Langmuir-Blodgett films. Chem. Commun., 2856-2857 (2002).

[88] Koide, Y., Terasaki, N., Akiyama, T. & Yamada, S. Effects of spacer-chain length on the photoelectrochemical responses of monolayer assemblies with ruthenium tris(2, 2′-bipyridine)-viologen linked disulfides. Thin Solid Films 350, 223-227 (1999).

[89] Terasaki, N., Akiyama, T. & Yamada, S. Structural characterization and photoelectrochemical properties of the self-assembled monolayers of tris(2,2′-bipyridine)ruthenium(II)-viologen linked compounds formed on the gold surface. Langmuir 18, 8666-8671 (2002).

[90] Soto, E., MacDonald, J. C., Cooper, C. G. F. & McGimpsey, W. G. A non-covalent strategy for the assembly of supramolecular photocurrent-generating systems. J. Am. Chem. Soc. 125, 2838-2839 (2003).

[91] Imahori, H., Yamada, H., Nishimura, Y., Yamazaki, I. & Sakata, Y. Vectorial multistep electron transfer at the gold electrodes modified with self-assembled monolayers of ferrocene-porphyrin- fullerene triads. J. Phys. Chem. B 104, 2099-2108 (2000).

[92] Imahori, H. et al. Spectroscopy and photocurrent generation in nanostructured thin films of porphyrin-fullerene dyad clusters. Chem. Lett., 784-785 (2001).

[93] Imahori, H. et al. An investigation of photocurrent generation by gold electrodes modified with self-assembled monolayers of C-60. J. Phys. Chem. B 103, 7233-7237 (1999).

[94] Imahori, H., Yamada, H., Ozawa, S., Ushida, K. & Sakata, Y. Synthesis and photoelectrochemical properties of a self- assembled monolayer of a ferrocene-porphyrin-fullerene triad on a gold electrode. Chem. Commun., 1165-1166 (1999).

[95] Hirayama, D. et al. Preparation and photoelectrochemical properties of gold electrodes modified with 60 fullerene-linked oligothiophenes. Chem. Lett., 570-571 (2000). 20. Waldeck, D. H., Alivisatos, A. P. & Harris, C. B. Nonradiative damping of molecular electronic excited states by metal surfaces. Surf. Sci. 158, 103-125 (1985).

[96] Fox, M. A., Whitesell, J. K. & McKerrow, A. J. Fluorescence and redox activity of probes anchored through an aminotrithiol to polycrystalline gold. Langmuir 14, 816-820 (1998).

[97] Giese, B. & Biland, A. Recent developments of charge injection and charge transfer in DNA. Chem. Commun. 7, 667-672 (2002).

[98] Porath, D., Bezryadin, A., De Vries, S. & Dekker, C. Direct measurement of electrical transport through DNA molecules. Nature 403, 635-638 (2000).

[99] Compton, R. G., Coles, B. A. & Pilkington, M. B. G. Photoelectrochemical electron spin resonance. 3. The reduction of fluorescein: A photo-disp2 reaction. J. Chem. Soc., Faraday Trans. 84, 4347-4357 (1988).

[100] Emeline, A. V., Kuzmin, G. N., Purevdorj, D., Ryabchuk, V. K. & Serpone, N. Spectral dependencies of the quantum yield of photochemical processes on the surface of wide band gap solids. 3. Gas/solid systems. J. Phys. Chem. B 104, 2989-2999 (2000).

[101] Morton, R. A. Biochemical spectroscopy (Wiley, New York, 1975).

[102] Gorton, L. & Dominguez, E. in Bioelectrochemistry (ed. Wilson, G. E.) 67-143 (Wiley-VCH, Weinheim, 2002).

[103] Elving, P. J., Schmakel, C. O. & Santhanam, K. S. V. Nicotinamide-nad sequence: Redox processes and related behavior: Behavior and properties of intermediate and final products. Crit. Rev. Anal. Chem. 6,1-67 (1976).

[104] Long, Y.-T. et al. A comparison of electron-transfer rates of ferrocenoyl-linked DNA. J. Am. Chem. Soc. 125, 8724-8725 (2003).

We claim

1. A photocurrent generating system comprising:
(a) providing an electron transfer moiety tethered to an electrode by a conductive spacer moiety;
(b) applying a biasing potential to the electrode to reduce the electron transfer moiety to form a reduced electron transfer species capable of absorbing a photon to form an excited electron transfer species;
(c) providing an electron accepting moiety capable of accepting an electron from the excited electron transfer species, to form a reduced electron acceptor.

2. The system of claim 1, wherein the electron accepting moiety is provided in an electron transfer solution.

3. The system of claim 2, wherein the electron transfer solution is an aqueous solution capable of providing protons to the reduced electron acceptor

4. The system of claim 2, wherein the tethered electron transfer moiety is immersed in the electron transfer solution, to provide for repeated electron transfer reactions between the excited electron transfer species and successive electron accepting moieties in the solution.

5. The system of claim 1, wherein the bias that is applied to the electrode to form the reduced electron transfer species is less than the potential that would be required to form the reduced electron acceptor.

6. The system of claim 1, wherein the rate at which the reduced electron transfer species is created is greater than the rate at which the excited electron transfer species donates an electron to the electron acceptor.

7. The system of claim 1, wherein the electron transfer moiety is a fluorescein.

8. The system of claim 1, wherein the electrode is gold.

9. The system of claim 1, wherein the conductive spacer moiety is a nucleic acid.

10. The system of claim 1, wherein the electron accepting moiety is NAD+ or NADP+.

11. The system of claim 10, further comprising an enzyme in said electron transfer solution, wherein the enzyme utilises NADH or NADPH as a cofactor.

12. The system of claim 11, wherein the enzyme is a dehydrogenase.

13. The system of claim 11, wherein the enzyme is an alcohol dehydrogenase.

14. The system of claim 11, wherein the enzyme is a reductase.
